(19) United States
(12) Patent Application Publication
(10) Pub. No.: US 2009/0284298 A1
(43) Pub. Date: Nov. 19, 2009

(54) METHOD FOR AUTOMATICALLY ADJUSTING CLOCK FREQUENCY AND CLOCK FREQUENCY ADJUSTING CIRCUIT

(75) Inventor: Hsiang Sheng LIU, Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Hsin-Chu (TW)

(21) Appl. No.: 12/261,436

(22) Filed: Oct. 30, 2008

(30) Foreign Application Priority Data
May 14, 2008 (TW) 097117664

(51) Int. Cl. G06F 1/04

(52) U.S. Cl. 327/299

(57) ABSTRACT

A method for automatically adjusting the clock frequency for a USB interface including the steps of: generating a clock signal with an adjustable frequency; receiving a USB differential signal; counting the clock signal based on each frame time of the USB differential signal and obtaining a count value; and adjusting the frequency of the clock signal when the count value exceeds a predetermined count range. The present invention further provides a clock frequency adjusting circuit.

### CROSS REFERENCE TO RELATED APPLICATION

This application claims the priority benefit of Taiwan Patent Application Serial Number 097117664, filed on May 14, 2008, the full disclosure of which is incorporated herein by reference.

### BACKGROUND OF THE INVENTION

1. Field of the Invention

This invention generally relates to a method for automatically adjusting clock frequency and a clock frequency adjusting circuit, and more particularly, to a method for automatically adjusting the clock frequency of the oscillator in a USB device and a clock frequency adjusting circuit thereof.

2. Description of the Related Art

A universal serial bus (USB) system is consisted of a USB host and a USB device connecting with a USB interface, wherein the data transmission between the USB host and the USB device has to meet a data transmission specification. For example, in a full-speed device, data transmission needs to be controlled within a range of 12 MHz±0.25%; however, in a low-speed device, data transmission needs to be controlled within a range of 1.5 MHz±1.5%. A current method for controlling the clock frequency of the oscillator in a USB device to meet the above specification is to install a quartz oscillator so as to increase the accuracy of the clock frequency. However, in the chip using a quartz oscillator, it is necessary to add additional 1˜2 pins to connect the quartz oscillator and therefore the cost will be increased.

In a conventional circuit for locking an oscillator, such as U.S. Pat. No. 6,297,705 and entitled “Circuit for locking an oscillator to a data stream”, it utilizes a counter to compare the output frequency of a digital control oscillator with the frequency of a USB device, and coarsely and finely tunes the output frequency of the digital control oscillator until its output frequency synchronizes with the frequency of the USB device. However, the above circuit needs to use the whole signal package to adjust the frequency and therefore it needs a longer adjusting time.

Another conventional method for regulating an oscillator applicable to a low-speed USB interface, such as U.S. Pat. No. 7,127,628 and entitled “Method for automatically regulating an oscillator”, includes the steps of: (a) providing a voltage-controlled oscillator in a USB interface for generating a controllable oscillating signal to a USB electronic device; (b) feeding back the controllable oscillating signal to a frequency comparing unit for comparing the controllable oscillating signal with a Keep Alive Strobe signal in the USB interface; (c) inputting an output signal of the frequency comparing unit to a frequency regulating unit for changing the frequency of the controllable oscillating signal according to a signal regulating voltage fed back from the frequency comparing unit; and (d) repeating steps (b) and (c) to synchronize the controllable oscillating signal with the Keep Alive Strobe signal in the USB interface; so that the USB interface connecting system and the USB electronic device may be quickly synchronized for data transmission. However, the above method is only limited to a low-speed USB interface connecting system.

When a USB device is connected to a USB interface, the USB device will receive USB differential signals, which begin with a USB reset signal. In each frame time, i.e. 1 ms, of the USB differential signals behind the USB reset signal, the USB device will always receive a Keep Alive signal (for low-speed device) or a start of frame (referred as SOF herein) signal (for full-speed device), continuously. The present invention further provides a method for automatically adjusting an oscillator by utilizing these continuous signals so as to effectively reduce the cost, simplify the system circuit and decrease the size of circuit board.

### SUMMARY OF THE INVENTION

It is an object of the present invention to provide a method for automatically adjusting clock frequency and a clock frequency adjusting circuit, wherein an oscillator with an adjustable clock frequency is disposed inside the control IC of a USB device and the clock frequency of the oscillator is adjusted according to a Keep Alive signal or a SOF signal of the USB interface so as to effectively increase the accuracy of the clock frequency.

It is another object of the present invention to provide a method for automatically adjusting clock frequency and a clock frequency adjusting circuit, wherein it only needs to dispose an oscillator with an adjustable clock frequency inside the control IC of a USB device, without using a quartz oscillator, so as to decrease the cost, simplify the system circuit and reduce the size of the circuit board.

In order to achieve above objects, the present invention provides a method for automatically adjusting clock frequency for a USB interface. The method includes the steps of: generating a clock signal with an adjustable frequency; receiving a USB differential signal; counting the clock signal based on each frame time of the USB differential signal and obtaining a count value; and adjusting the frequency of the clock signal when the count value exceeds a predetermined count range.

In the above method for automatically adjusting clock frequency, when the USB interface is a low-speed USB interface, each frame time of the USB differential signal is a time interval between two consecutive Keep Alive signals; when the USB interface is a full-speed USB interface, each frame time of the USB differential signal is a time interval between two consecutive SOF signals.

According to another aspect of the present invention, the present invention further provides a clock frequency adjusting circuit for a USB interface including an oscillator and a calibration circuit. The oscillator is for generating a clock signal with an adjustable frequency. The calibration circuit includes a first input, a second input and a signal output; wherein the first input of the calibration unit receives the clock signal generated by the oscillator; the second input receives a USB differential signal; the calibration unit counts the clock signal based on each frame time of the USB differential signal so as to accordingly generate a control signal, which is outputted from the signal output of the calibration unit and transmitted to the oscillator, to adjust the frequency of the clock signal.

According to another aspect of the present invention, the present invention further provides a method for automatically adjusting clock frequency for a USB interface. The method includes the steps of: generating a clock signal with an adjustable frequency; receiving a USB differential signal; counting the clock signal based on each frame time of the USB differential signal; and adjusting the frequency of the clock signal according to a result of counting the clock signal.

The method for automatically adjusting clock frequency according to the present invention adjusts the clock signal frequency according to the Keep Alive signal and the SOF signal of a USB interface. Because those signals are regulated in the specification within a range between 1 ms±0.05%, they have a very small error range and thus can be served as a reference for adjusting the clock frequency of the built-in oscillator of a USB device. In this manner, an additional quartz oscillator needs not to be installed in the USB device related to the present invention so as to effectively reduce the manufacturing cost.

### BRIEF DESCRIPTION OF THE DRAWINGS

Other objects, advantages, and novel features of the present invention will become more apparent from the following detailed description when taken in conjunction with the accompanying drawings.

FIG. 1 shows a timing diagram of differential signals when a USB device is connected to a USB system.

FIG. 2 shows a block diagram of the clock frequency adjusting circuit according to one embodiment of the present invention.

FIG. 3 shows a flow chart of the method for automatically adjusting clock frequency according to one embodiment of the present invention.

### DETAILED DESCRIPTION OF THE PREFERRED EMBODIMENT

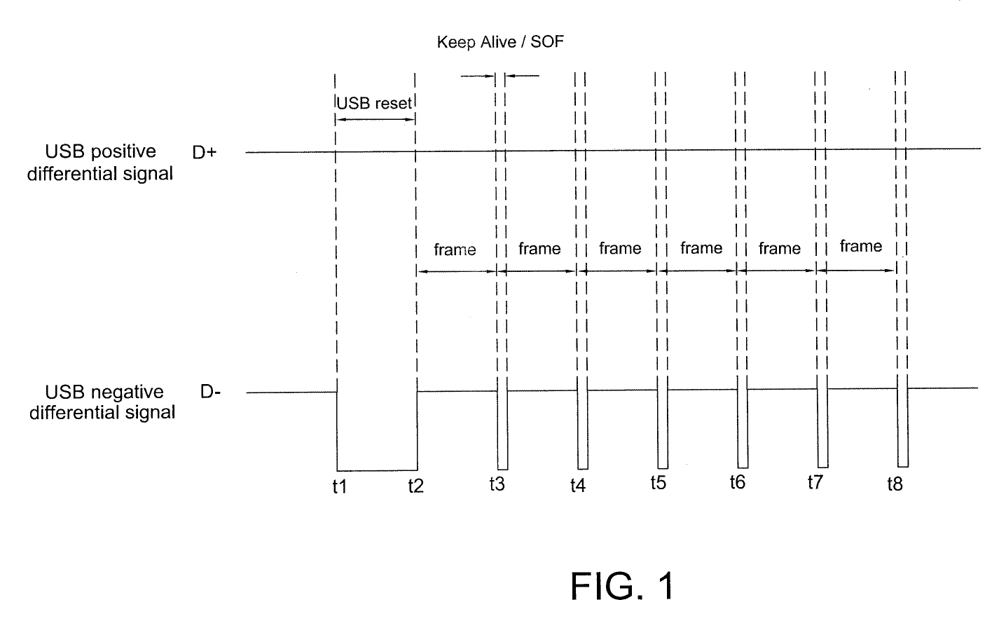

Referring to FIG. 1, it shows a timing diagram of differential signals when a USB device is connected to a USB system according to one embodiment of the present invention, including a USB positive differential signal D+ and a USB negative differential signal D−. During the initial period of connection, e.g. a time interval t1˜t2, the USB device will receive a USB reset signal from the USB interface. Then, the USB device will always receive a Keep Alive signal (for low-speed devices) or a start of frame (SOF) signal (for full-speed devices) after each frame time, i.e. 1 ms, such as time intervals t2˜t3, t3˜t4 . . . . The present invention uses these signals, i.e. Keep Alive signal or SOF signal, as reference signals for adjusting the oscillator in a USB device.

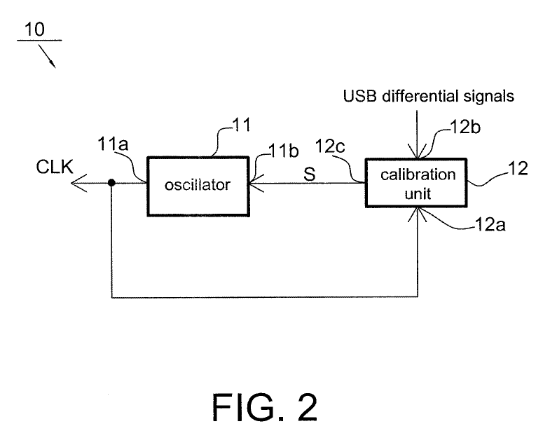

Referring to FIG. 2, it shows a block diagram of the clock frequency adjusting circuit 10 according to one embodiment of the present invention. The clock frequency adjusting circuit 10 includes an oscillator 11 and a calibration unit 12. The oscillator 11 is for generating a clock signal CLK with an adjustable frequency, and has an output 11a and an input 11b. The oscillator 11 may be, but not limited to, an RC oscillator.

Referring to FIGS. 1 and 2 again, the calibration unit 12 is for outputting a control signal S to adjust the frequency of the clock signal CLK outputted from the oscillator 11, and includes a first input 12a, a second input 12b and a signal output 12c. The first input 12a receives the feedback signal of the clock signal CLK generated by the oscillator 11; the second input 12b receives USB differential signals from the USB system. The calibration unit 12 counts the clock signal CLK based on each frame time of the USB differential signals, e.g. t2˜t3, t3˜t4 . . . , and generates the control signal S according to a result of counting the clock signal CLK so as to accordingly adjust the frequency of the clock signal CLK generated by the oscillator 11. The control signal S may be, for example, a digital signal. If the oscillator 11 is an RC oscillator, the control signal S can be used to regulate the value of R, the value of C, or the values of R and C.

In one embodiment, it is assumed that the USB device is a full-speed device. According to the data transmission specification of a USB system, the frequency of the clock signal CLK may be, for example 6 MHz and the frame time between two consecutive SOF signals in USB differential signals is 1 ms; thus a predetermined count value can be obtained as [1 ms/(1/6MHz)]=6000 and a tolerable error range of the frequency of the clock signal CLK is between ±0.25% of the predetermined count value. That is, a count value obtained by the calibration unit 12 for counting the clock signal CLK based on each frame time of the USB differential signals should be between 5985 and 6015. The clock signal CLK generated by the oscillator 11 will not fix at 6 MHz due to the influence of manufacturing processes and operating environments. When the count value obtained by the calibration unit 12 for counting the clock signal CLK based on each frame time of the USB differential signals is smaller than 5985, meaning that the frequency of the clock signal CLK is too low, the calibration unit 12 generates the control signal S to increase the frequency of the clock signal CLK generated by the oscillator 11. On the contrary, when the obtained count value is higher than 6015, meaning that the frequency of the clock signal CLK is too high, the calibration unit 12 generates the control signal S to decrease the frequency of the clock signal CLK generated by the oscillator 11. It can be understood that, the frequency of the clock signal CLK is not limited to 6 MHz, and it can be integral multiples of 6 MHz, such as 12 MHz, 18 MHz, 24 MHz, and so on. The predetermined count range can be determined according to different clock signal frequency.

In addition, when the USB device is a low-speed device, according to the data transmission specification of a USB system, the frequency of the clock signal CLK may be 1.5 MHz, and the frame time between two consecutive Keep Alive signals in USB differential signals is also 1 ms; thus a predetermined count value can be determined as 1500 and a tolerable error range of the frequency of the clock signal CLK is between ±1.5% of the predetermined count value. That is, a count value obtained by the calibration unit 12 for counting the clock signal CLK based on each frame time of the USB differential signals should be between 1477.5 and 1522.5. The calibration unit 12 also determines whether the count value exceeds the predetermined count value or not and accordingly generates the control signal S to control the frequency of the clock signal CLK generated by the oscillator 11.

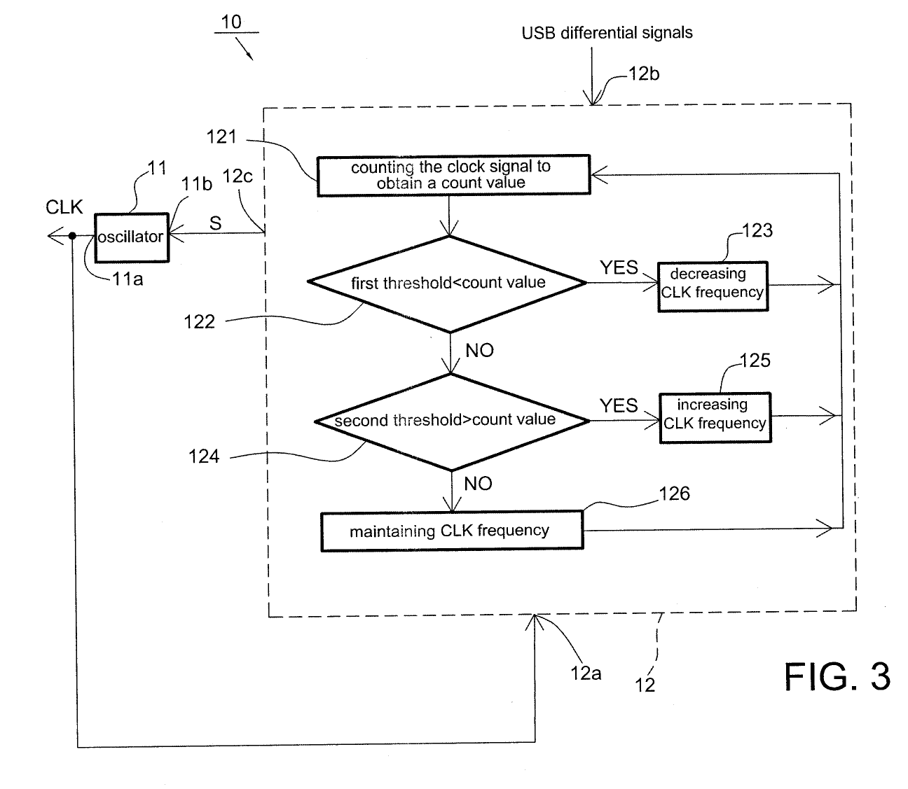

Referring to FIGS. 2 and 3, FIG. 3 shows a flow chart of the method for automatically adjusting clock frequency according to one embodiment of the present invention. Firstly, the oscillator 11 outputs a clock signal CLK with an adjustable frequency from its output 11a, and the clock signal CLK is fed back to the calibration unit 12 through the first input 12a of the calibration unit 12. In the meanwhile, the calibration unit 12 receives the USB differential signals from a USB interface through its second input 12b. Next, the calibration unit 12 counts the clock signal CLK based on each frame time of the USB differential signals and so as to obtain a count value (step 121). The calibration unit 12 determines whether the count value is larger than a first threshold, e.g. 6015 in a full-speed device (step 122). When the count value is larger than the first threshold, the calibration unit 12 generates a control signal S to be transmitted to the oscillator 11 so as to decrease the frequency of the clock signal CLK (step 123); otherwise, the calibration unit 12 then determines whether the count value is smaller than a second threshold, e.g. 5985 in a full-speed device (step 124). When the count value is smaller than the second threshold, the calibration unit 12 generates a control signal S to the oscillator 11 so as to increase the frequency of the clock signal CLK (step 126); otherwise the frequency of the clock signal CLK generated by the oscillator 11 should be maintained unchanged. Then the process returns to step 121 to perform the counting of the clock signal CLK repeatedly. When the frequency of the clock signal CLK appears deviation, the frequency will be adjusted immediately so as to maintain the frequency accuracy of the clock signal CLK generated by the oscillator 11. It should be appreciated that, the sequences of the steps 122, 123 and the steps 124, 125 can be exchanged.

As mentioned above, in conventional art, the method to increase the accuracy of oscillating frequency by installing a quartz oscillator inside the chip of a USB device will increase the cost and circuit complexity. In the present invention, the clock signal frequency of an oscillator can be dynamically adjusted by installing an oscillator with an adjustable frequency inside the chip of a USB device as well as using the Keep Alive signals or SOF signals of the USB differential signal as a reference for adjusting frequency. The frequency accuracy can be increased and the cost can be reduced at the same time.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A method for automatically adjusting clock frequency for a USB interface, comprising the steps of:
generating a clock signal with an adjustable frequency;
receiving a USB differential signal;
counting the clock signal based on each frame time of the USB differential signal and obtaining a count value; and
adjusting the frequency of the clock signal when the count value exceeds a predetermined count range.

2. The method for automatically adjusting clock frequency as claimed in claim 1, wherein the USB interface is a low-speed USB interface and each frame time of the USB differential signal is a time interval between two consecutive Keep Alive signals.

3. The method for automatically adjusting clock frequency as claimed in claim 2, wherein the predetermined count range is between (1 ms×1.5 MHz)±1.5%.

4. The method for automatically adjusting clock frequency as claimed in claim 1, wherein the USB interface is a full-speed USB interface and each frame time of the USB differential signal is a time interval between two consecutive SOF signals.

5. The method for automatically adjusting clock frequency as claimed in claim 4, wherein the predetermined count range is between (1 ms×n×1.5 MHz)±1.5%, and n is a positive integer.

6. The method for automatically adjusting clock frequency as claim in claim 1, wherein the predetermined count range is between a first threshold and a second threshold smaller than the first threshold; decreasing the frequency of the clock signal when the count value is larger than the first threshold.

7. The method for automatically adjusting clock frequency as claim in claim 1, wherein the predetermined count range is between a first threshold and a second threshold smaller than the first threshold; increasing the frequency of the clock signal when the count value is smaller than the second threshold.

8. A clock frequency adjusting circuit for a USB interface, comprising:
an oscillator for generating a clock signal with an adjustable frequency; and
a calibration circuit comprising a first input, a second input and a signal output;
wherein the first input of the calibration unit receives the clock signal generated by the oscillator; the second input receives a USB differential signal; the calibration unit counts the clock signal based on each frame time of the USB differential signal so as to accordingly generate a control signal, which is outputted from the signal output of the calibration unit and transmitted to the oscillator, to adjust the frequency of the clock signal.

9. The clock frequency adjusting circuit as claimed in claim 8, wherein the oscillator is an RC oscillator.

10. The clock frequency adjusting circuit as claimed in claim 9, wherein the control signal is for regulating the value of R.

11. The clock frequency adjusting circuit as claimed in claim 9, wherein the control signal is for regulating the value of C.

12. The clock frequency adjusting circuit as claimed in claim 9, wherein the control signal is for regulating the values of R and C.

13. The clock frequency adjusting circuit as claimed in claim 8, wherein the USB interface is a low-speed USB interface and each frame time of the USB differential signal is a time interval between two consecutive Keep Alive signals.

14. The clock frequency adjusting circuit as claimed in claim 8, wherein the USB interface is a full-speed USB interface and each frame time of the USB differential signal is a time interval between two consecutive SOF signals.

15. The clock frequency adjusting circuit as claimed in claim 8, wherein the control signal is a digital signal.

16. A method for automatically adjusting clock frequency for a USB interface, comprising the steps of:
generating a clock signal with an adjustable frequency;
receiving a USB differential signal;
counting the clock signal based on each frame time of the USB differential signal; and
adjusting the frequency of the clock signal according to a result of counting the clock signal.

17. The method for automatically adjusting clock frequency as claimed in claim 16, wherein the USB interface is a low-speed USB interface and each frame time of the USB differential signal is a time interval between two consecutive Keep Alive signals.

18. The method for automatically adjusting clock frequency as claimed in claim 16, wherein the USB interface is a full-speed USB interface and each frame time of the USB differential signal is a time interval between two consecutive SOF signals.
